(19) United States
(12) Patent Application Publication
(10) Pub. No.: US 2025/0263569 A1
(43) Pub. Date: Aug. 21, 2025

(54) Ink Jet Ink Composition And Recording Method

(71) Applicant: SEIKO EPSON CORPORATION, Tokyo (JP)

(72) Inventors: Tomoki MIMURA, Matsumoto (JP); Yusuke FUJISAWA, Shiojiri (JP)

(21) Appl. No.: 19/054,035

(22) Filed: Feb. 14, 2025

(30) Foreign Application Priority Data
Feb. 16, 2024 (JP) 2024-021802

(51) Int. Cl. C09D 11/38; C08K 5/5313

(52) U.S. Cl. CPC C09D 11/38; C08K 5/5313

(57) ABSTRACT

An ink jet ink composition includes a polymerization initiator and a hydroxy group-containing monomer, contains no aromatic group-containing polymerizable compound, or contains an aromatic group-containing polymerizable compound in an amount of 5.0 mass % or less based on the total amount of the ink jet ink composition, and contains no water, or contains water in an amount of less than 2 mass % based on the total amount of the ink jet ink composition, wherein the polymerization initiator includes ethyl phenyl (2,4,6-trimethylbenzoyl)phosphinate.

The present application is based on, and claims priority from JP Application Serial Number 2024-021802, filed Feb. 16, 2024, the disclosure of which is hereby incorporated by reference herein in its entirety.

### BACKGROUND

### 1. Technical Field

The present disclosure relates to an ink jet ink composition and a recording method.

### 2. Related Art

An ink jet recording method is capable of recording high-resolution images with a relatively simple apparatus, and is rapidly developing in various fields. Various studies have been made on the storage stability of an ink jet ink composition. For example, WO 2022/180962 discloses a UV-curable aqueous ink composition for ink jet printing, which contains 20.0 to 70.0 mass % of a water-soluble acrylamide monomer, 5.0 to 60.0 mass % of a water-soluble hydroxy group-containing monofunctional monomer, and 8.0 to 35.0 mass % of a water-insoluble polymerizable compound based on the total mass of all polymerizable components, contains 3.0 to 10.0 parts by mass of a photopolymerization initiator and/or a sensitizer based on 100 parts by mass of the total mass of all polymerizable components, and also contains a pigment and water. The mass ratio of the water-soluble acrylamide monomer to the water-soluble hydroxy group-containing monofunctional monomer (acrylamide monomer/hydroxy group-containing monofunctional monomer) is 0.3 to 10.0. By irradiating the ink composition with ultraviolet light in an accumulated light amount of 100 mJ/cm² or less using a UV-LED having a peak wavelength of 365 to 405 nm, the ink composition is cured temporarily and has excellent storage stability.

However, a coating of the ink composition disclosed in the above-cited patent document has an insufficient curability and a problematic odor. Further, the present inventors, through their studies to store an ink composition in a variety of environments while preventing deterioration in quality, found new problems such as the generation of foreign matter in an ink composition during its long-term storage under low-temperature or high-temperature conditions. For example, during long-term storage of an ink composition under low-temperature conditions, a polymerization initiator in the ink composition may precipitate as foreign matter. During long-term storage of an ink composition under high-temperature conditions, foreign matter may be generated due to the influence of moisture in the ink composition. Various such problems with the storage stability of an ink composition have now been found out.

### SUMMARY

According to an aspect of the present disclosure, an ink jet ink composition comprises ethyl phenyl (2,4,6-trimethylbenzoyl)phosphinate and a hydroxy group-containing monomer, contains no aromatic group-containing polymerizable compound, or contains an aromatic group-containing polymerizable compound in an amount of 5.0 mass % or less based on the total amount of the ink jet ink composition, and contains no water, or contains water in an amount of less than 2 mass % based on the total amount of the ink jet ink composition.

According to another aspect of the present disclosure, a recording method comprises an ejection step of ejecting the above ink jet ink composition from an ink jet head and attaching the composition to a recording medium.

### BRIEF DESCRIPTION OF THE DRAWINGS

FIG. 1 is a table showing the results of Examples.

FIG. 2 is a table showing the results of Examples.

FIG. 3 is a table showing the results of Comparative Examples.

### DESCRIPTION OF EMBODIMENTS

Embodiments of the present disclosure (hereinafter referred to as “the present embodiments”) will now be described in detail. The embodiments described herein are for illustration of the present disclosure and are not to be construed as limiting thereof. It is to be understood that the scope of the present disclosure should be determined based on the claims, and that various changes and modifications can be made to the embodiments without departing from the spirit and scope of the present disclosure. As used herein, a numerical range such as “1 to 100” includes both the lower limit “1” and the upper limit “100”. The same holds true for other numerical ranges.

As used herein, “(meth)acryloyl” refers to at least one of acryloyl and the corresponding methacryloyl, “(meth)acrylate” refers to at least one of acrylate and the corresponding methacrylate, and “(meth)acrylic” refers to at least one of acrylic and the corresponding methacrylic.

### 1. Ink Jet Ink Composition

The ink jet ink composition according to the present embodiments (hereinafter also referred to simply as “the ink composition”) comprises ethyl phenyl (2,4,6-trimethylbenzoyl)phosphinate and a hydroxy group-containing monomer, contains no aromatic group-containing polymerizable compound, or contains an aromatic group-containing polymerizable compound in an amount of 5.0 mass % or less based on the total amount of the ink jet ink composition, and contains no water, or contains water in an amount of less than 2 mass % based on the total amount of the ink jet ink composition.

It has been found that when a conventional ink jet ink composition containing, for example, 2,4,6-trimethylbenzoyldiphenylphosphine oxide as a polymerization initiator is stored for a long period of time in a low-temperature environment, the polymerization initiator in the ink jet ink composition may precipitate as foreign matter. When the ink jet ink composition is stored in a high-temperature environment, foreign matter may be generated due to moisture in the ink jet ink composition. In addition, a coating of the ink jet ink composition has insufficient odor and curability.

These problems can be successfully dealt with by the ink jet ink composition according to the present embodiments. In particular, ethyl phenyl(2,4,6-trimethylbenzoyl)phosphinate, which is contained as a polymerization initiator in the ink jet ink composition, can be prevented from being precipitated even when the composition is stored under low-temperature conditions for a long period of time. Further, the inclusion of a hydroxy group-containing monomer, which has good compatibility with the polymerization initiator, can improve the curability of the ink jet ink composition. Further, the content of an aromatic group-containing polymerizable compound within the specified range can reduce the odor of the ink jet ink composition. In addition, the content of water within the specified range can suppress the generation of foreign matter due to moisture in the ink jet ink composition even when the composition is stored under high-temperature conditions for a long period of time.

The ink composition according to the present embodiments is an ink composition which is to be ejected from an ink jet head in an ink jet process, and may be a radiation-curable ink jet ink composition which is cured by exposure to radiation. A radiation-curable ink composition will be described hereinbelow as an embodiment of the ink composition. It is to be noted that the composition according to the present embodiments may be a composition other than an ink composition, for example a composition for use in 3D additive manufacturing.

The radiation-curable ink composition is cured by exposing it to radiation. Examples of the radiation include ultraviolet light, electron beam, infrared light, visible light, and X-rays. Ultraviolet light is preferred as radiation because UV radiation sources are readily available and widely used, and materials suitable for curing by ultraviolet radiation are readily available and widely used.

### 1.1. Photopolymerization Initiator

The ink composition of the present embodiments contains ethyl phenyl (2,4,6-trimethylbenzoyl)phosphinate as a photopolymerization initiator, and may contain other photopolymerization initiator(s) as necessary.

The total content of the photopolymerization initiator(s) is preferably 4 to 17 mass %, 8 to 16 mass %, or 12 to 15 mass % based on the total amount of the ink composition.

1.1.1. Ethyl phenyl (2,4,6-trimethylbenzoyl)phosphinate

Ethyl phenyl (2,4,6-trimethylbenzoyl)phosphinate is a photopolymerization initiator, and is a reactant which absorbs radiation when irradiated with the radiation, thereby generating radicals and progressing polymerization of the ink composition.

Ethyl phenyl (2,4,6-trimethylbenzoyl)phosphinate, which is contained in the ink composition and functions as a polymerization initiator, can be prevented from being precipitated even when the composition is stored under low-temperature conditions for a long period of time. Thus, the ink composition has excellent storage stability.

The content of ethyl phenyl (2,4,6-trimethylbenzoyl)phosphinate is preferably 1 to 14 mass %, 2 to 12 mass %, 3 to 10 mass %, or 4 to 10 mass % based on the total amount of the ink composition. When the content of ethyl phenyl (2,4,6-trimethylbenzoyl)phosphinate is within the above ranges, the storage stability of the ink composition under low-temperature conditions tends to be further improved.

The content of ethyl phenyl (2,4,6-trimethylbenzoyl)phosphinate is preferably 10 to 100 mass %, 20 to 90 mass %, or 30 to 80 mass % based on the total amount of the photopolymerization initiator(s). When the content of ethyl phenyl (2,4,6-trimethylbenzoyl)phosphinate is within the above ranges, the storage stability and curability of the ink composition under low-temperature conditions tend to be further improved.

An example of a commercially available product of ethyl phenyl (2,4,6-trimethylbenzoyl)phosphinate is IRGACURE TPO-L (manufactured by BASF Corporation).

### 1.1.2. Other Photopolymerization Initiators

The ink composition according to the present embodiments may further contain a photopolymerization initiator(s) other than ethyl phenyl (2,4,6-trimethylbenzoyl)phosphinate. The other photopolymerization initiator(s) may be of a single type or of a combination of two or more types. The inclusion of the other photopolymerization initiator(s) further improves the curability of the ink composition.

The other photopolymerization initiator(s) is not particularly limited as long as it generates an active species when exposed to radiation. Examples of the other photopolymerization initiator(s) include known photopolymerization initiators such as an acylphosphine oxide photopolymerization initiator other than ethyl phenyl (2,4,6-trimethylbenzoyl)phosphinate, an alkylphenone photopolymerization initiator, a titanocene photopolymerization initiator, and a thioxanthone photopolymerization initiator. Among them, an acylphosphine oxide photopolymerization initiator is preferred. The use of such a photopolymerization initiator in combination with ethyl phenyl (2,4,6-trimethylbenzoyl)phosphinate tends to further improve the curability of the ink composition, in particular the curability in a curing process using UV-LED light. Therefore, both the storage stability under low-temperature conditions and the curability of the ink composition can be made excellent.

Examples of the acylphosphine oxide photopolymerization initiator include, and are not limited to, 2,4,6-trimethylbenzoyldiphenylphosphine oxide, bis(2,4,6-trimethylbenzoyl)-phenylphosphine oxide, and bis-(2,6-dimethoxybenzoyl)-2,4,4-trimethylpentylphosphine oxide.

Examples of commercially available products of such an acylphosphine oxide photopolymerization initiator include IRGACURE 819 (bis(2,4,6-trimethylbenzoyl)-phenylphosphine oxide), IRGACURE 1800 (a mixture of bis-(2,6-dimethoxybenzoyl)-2,4,4-trimethylpentylphosphine oxide and 1-hydroxy-cyclohexyl-phenyl ketone at a mass ratio of 25:75), and IRGACURE TPO (2,4,6-trimethylbenzoyldiphenylphosphine oxide), all manufactured by BASF Corporation.

The content of the acylphosphine oxide photopolymerization initiator is preferably 0.5 to 10.0 mass %, 2.0 to 8.5 mass %, or 4.0 to 7.0 mass % based on the total amount of the ink composition.

Examples of the thioxanthone photopolymerization initiator include, and are not limited to, thioxanthone, 2-methylthioxanthone, 2,4-diethylthioxanthone, 2-isopropylthioxanthone, 4-isopropylthioxanthone, 2-chlorothioxanthone, and 2,4-diethylthioxanthone.

Examples of commercially available products of the thioxanthone photopolymerization initiator include KAYACURE DETX-S (2,4-diethylthioxanthone, trade name of Nippon Kayaku Co., Ltd.), Speedcure DETX (2,4-diethylthioxanthone, trade name of LAMBSON Ltd.), and KAYACURE ITX (2-/4-isopropylthioxanthone, trade name of Nippon Kayaku Co., Ltd.).

The content of the thioxanthone oxide photopolymerization initiator is preferably 0.5 to 5.0 mass %, 1.0 to 4.0 mass %, or 2.0 to 3.0 mass % based on the total amount of the ink composition.

### 1.2. Polymerizable Compound

The ink jet ink composition of the present embodiments comprises a hydroxy group-containing monomer as a polymerizable compound, and contains no aromatic group-containing polymerizable compound, or contains an aromatic group-containing polymerizable compound in an amount of 5.0 mass % or less based on the total amount of the ink jet ink composition. The ink composition of the present embodiments may contain a monofunctional monomer containing no hydroxy group, such as an aliphatic ring-containing monofunctional monomer, an oxygen-containing cyclic monofunctional monomer, or a nitrogen-containing cyclic monofunctional monomer, as necessary. Further, the ink composition may contain a polyfunctional monomer containing no hydroxy group.

The content of the monofunctional monomer is preferably 10 to 80 mass %, 15 to 70 mass %, or 20 to 50 mass % based on the total amount of the ink composition.

The content of the polyfunctional monomer is preferably 20 to 80 mass %, 30 to 70 mass %, or 40 to 60 mass % based on the total amount of the ink composition.

### 1.2.1. Hydroxy Group-Containing Monomer

The hydroxy group-containing monomer of the present embodiments is not particularly limited, and may be a hydroxy group-containing monofunctional monomer having one polymerizable functional group, or a hydroxy group-containing polyfunctional monomer having a plurality of polymerizable functional groups. The hydroxy group-containing monomer may be of a single type or of a combination of two or more types.

Examples of the hydroxy group-containing monomer include, and are not limited to, hydroxy group-containing monofunctional monomers, for example, hydroxyalkyl (meth)acrylates such as 2-hydroxyethyl (meth)acrylate, 2-hydroxypropyl (meth)acrylate, 3-hydroxypropyl (meth)acrylate, 3-hydroxybutyl (meth)acrylate, and 4-hydroxybutyl (meth)acrylate; hydroxycycloalkyl methacrylates such as 1,4-cyclohexanedimethanol monoacrylate; or acrylamides such as N-hydroxymethyl (meth)acrylamide; and polyfunctional monomers such as pentaerythritol triacrylate.

Among them, 4-hydroxybutyl (meth)acrylate and 1,4-cyclohexanedimethanol monoacrylate (CHDMMA), which are hydroxy group-containing monofunctional monomers, are preferred, and 4-hydroxybutyl acrylate (4-HBA) is particularly preferred. The use of such a hydroxy group-containing monomer tends to improve the adhesion and curability of a coating.

The content of the hydroxy group-containing monomer is preferably 5 to 50 mass %, 10 to 45 mass %, or 20 to 40 mass % based on the total amount of the ink composition. When the content of the hydroxy group-containing monomer is within the above ranges, the adhesion and curability of a coating tend to be further improved.

### 1.2.2. Aromatic Group-Containing Polymerizable Compound

The ink jet ink composition of the present embodiments preferably does not contain an aromatic group-containing polymerizable compound. When the ink composition contains an aromatic group-containing polymerizable compound, its content is preferably low. No particular limitation is placed on the aromatic group-containing polymerizable compound as long as it has an aromatic group and one or more polymerizable functional groups. Examples of the aromatic group-containing polymerizable compound include an aromatic group-containing monofunctional monomer having one polymerizable functional group, and an aromatic group-containing polyfunctional monomer having a plurality of polymerizable functional groups. An oligomer having one or a plurality of polymerizable functional groups may also be used as the aromatic group-containing polymerizable compound as necessary. The aromatic group-containing polymerizable compound may be of a single type or of a combination of two or more types.

Examples of the aromatic group-containing polymerizable compound include, and are not limited to, phenoxyethyl (meth)acrylate, benzyl (meth)acrylate, alkoxylated 2-phenoxyethyl (meth)acrylate, ethoxylated nonylphenyl (meth)acrylate, alkoxylated nonylphenyl (meth)acrylate, p-cumylphenol EO-modified (meth)acrylate, and 2-hydroxy-3-phenoxypropyl (meth)acrylate.

When the ink composition contains an aromatic group-containing polymerizable compound, the content of the aromatic group-containing polymerizable compound is 5 mass % or less, preferably 1 mass % or less, or 0.1 mass % or less based on the total amount of the ink composition. While the lower limit of the content of the aromatic group-containing polymerizable compound is not particularly limited, the content is preferably as low as possible and may be zero (0 mass %, including 0 mass % as obtained by rounding a content value to one decimal place). When the content of the aromatic group-containing polymerizable compound is 5 mass % or less, the odor of a cured product of the ink composition tends to be reduced. The odor can be further reduced when the ink composition does not contain an aromatic group-containing polymerizable compound.

### 1.2.3. Other Polymerizable Compounds

The ink composition of the present embodiments may contain other polymerizable compound(s). The other polymerizable compound(s) may include a monofunctional monomer having one polymerizable functional group and containing no hydroxy group, and a polyfunctional monomer having a plurality of polymerizable functional groups, and may optionally include an oligomer having one or more polymerizable functional groups. Each polymerizable compound may be of a single type or of a combination of two or more types.

### 1.2.3.1. Monofunctional Monomer Containing No Hydroxy Group

Examples of the monofunctional monomer containing no hydroxy group include, and are not limited to, an aliphatic ring-containing monofunctional monomer, a nitrogen-containing cyclic monofunctional monomer, an oxygen-containing cyclic monofunctional monomer, a monofunctional (meth)acrylate having a crosslinked condensed ring structure, and a monofunctional monomer containing a saturated aliphatic group. Instead of or in addition to these monomers, the ink composition may contain other monofunctional monomer(s) as necessary. There is no particular limitation on the other monofunctional monomer(s); for example, it is possible to use a conventionally-known monofunctional monomer having a polymerizable functional group(s), in particular a polymerizable functional group(s) having a carbon-carbon unsaturated double bond. Among them, it is preferred to use one or more monomers selected from the group consisting of an aliphatic ring-containing monomer, an oxygen-containing cyclic monomer, and a nitrogen-containing cyclic monomer.

Examples of the aliphatic ring-containing monofunctional monomer include, and are not limited to, isobornyl (meth)acrylate (IBXA), tert-butylcyclohexanol acrylate (TBCHA), and 1,4-dioxaspiro[4,5]dec-2-ylmethyl 2-(meth)acrylate.

The content of the aliphatic ring-containing monofunctional monomer is preferably 1 to 30 mass %, 3 to 25 mass %, or 5 to 20 mass % based on the total amount of the ink composition. When the content of the aliphatic ring-containing monofunctional monomer is within the above ranges, the adhesion and curability of a coating tend to be further improved.

The oxygen-containing cyclic monofunctional monomer is not particularly limited and may be, for example, a cyclic ether monofunctional monomer such as cyclic trimethylolpropane formal acrylate (CTFA), cyclic trimethylolpropane formal methacrylate, tetrahydrofurfuryl acrylate (THFA), (2-methyl-2-ethyl-1,3-dioxolan-4-yl)methyl acrylate (MEDOL-10), and tetrahydrofurfuryl methacrylate.

The content of the oxygen-containing cyclic monofunctional monomer is preferably 1 to 40 mass %, 2 to 35 mass %, 3 to 30 mass %, or 5 to 30 mass % based on the total amount of the ink composition. When the content of the oxygen-containing cyclic monofunctional monomer is within the above ranges, the adhesion and curability of a coating tend to be further improved.

Examples of the nitrogen-containing monofunctional monomer include, and are not limited to, nitrogen-containing vinyl monomers such as vinylmethyloxazolidinone (VMOX), N-vinylcaprolactam, N-vinylcarbazole, and N-vinylpyrrolidone; nitrogen-containing acrylate monomers such as acryloylmorpholine; and nitrogen-containing acrylamide monomers such as (meth)acrylamide, diacetone acrylamide, N,N-dimethyl(meth)acrylamide, and dimethylaminoethyl acrylate benzyl chloride quaternary salt. Among them, nitrogen-containing vinyl monomers are preferred from the viewpoint of the adhesion and curability of a coating. Among nitrogen-containing vinyl monomers, an oxazolidine group-containing monofunctional monomer having an oxazolidine group is more preferred, and vinylmethyloxazolidinone (VMOX) is particularly preferred.

The content of the nitrogen-containing monofunctional monomer is preferably 3 to 30 mass %, 4 to 25 mass %, or 5 to 20 mass % based on the total amount of the ink composition. When the content of the nitrogen-containing monofunctional monomer is within the above ranges, the adhesion and curability of a coating tend to be further improved.

Among the above-described monofunctional monomers containing no hydroxy group, it is preferred to use one or more selected from the group consisting of isobornyl (meth)acrylate, cyclic trimethylolpropane formal acrylate, tert-butyl cyclohexanol acrylate, and vinylmethyloxazolidinone. The use of such a monofunctional monomer containing no hydroxy group tends to further improve the adhesion and curability of a coating.

The content of the monofunctional monomer containing no hydroxy group is preferably 0 to 70 mass %, 0 to 60 mass %, 0 to 55 mass %, or 0 to 50 mass % based on the total amount of the ink composition. When the content of the monofunctional monomer containing no hydroxy group is within the above ranges, the adhesion and curability of a coating tend to be further improved.

### 1.2.3.2. Polyfunctional Monomer

The ink composition of the present embodiments may further contain a polyfunctional monomer. Examples of the polyfunctional monomer include, and are not limited to, a vinyl ether group-containing (meth)acrylate and a polyfunctional (meth)acrylate.

### 1.2.3.2.1 Vinyl Ether Group-Containing (Meth)Acrylate

The vinyl ether group-containing (meth)acrylate is not particularly limited and may be, for example, a compound represented by the following formula (1):

CH₂═CR¹—COOR²—O—CH═CH—R³ (1)

where R¹ is a hydrogen atom or a methyl group, R² is a divalent organic residue having 2 to 20 carbon atoms, and R³ is a hydrogen atom or a monovalent organic residue having 1 to 11 carbon atoms. The inclusion of such a vinyl ether group-containing (meth)acrylate tends to reduce the viscosity of the composition, thereby further improving the ejection stability. In addition, the curability of the composition is further improved. The improvement in the curability enables a faster recording speed.

Examples of the divalent organic residue having 2 to 20 carbon atoms, represented by R² in the above formula (1), include a linear, branched or cyclic alkylene group, which may be substituted, having 2 to 20 carbon atoms, an alkylene group, which may be substituted, having 2 to 20 carbon atoms and having an oxygen atom(s) in an ether bond and/or an ester bond in the structure, and a divalent aromatic group, which may be substituted, having 6 to 11 carbon atoms. In particular, an alkylene group having 2 to 6 carbon atoms, such as an ethylene group, an n-propylene group, an isopropylene group, or a butylene group, and an alkylene group having 2 to 9 carbon atoms and having an oxygen atom in an ether bond in the structure, such as an oxyethylene group, an oxy n-propylene group, an oxyisopropylene group, or an oxybutylene group, are preferred. A compound having a glycol ether chain in which R² is an alkylene group having 2 to 9 carbon atoms and having an oxygen atom in an ether bond in the structure, such as an oxyethylene group, an oxy n-propylene group, an oxyisopropylene group, or an oxybutylene group, is more preferred from the viewpoint of being capable of further reducing the viscosity of the composition and further improving the curability of the composition.

The monovalent organic residue having 1 to 11 carbon atoms, represented by R³ in the above formula (1), is preferably a linear, branched or cyclic alkyl group, which may be substituted, having 1 to 10 carbon atoms, or an aromatic group, which may be substituted, having 6 to 11 carbon atoms. In particular, an alkyl group having 1 to 2 carbon atoms, namely a methyl group or an ethyl group, and an aromatic group having 6 to 8 carbon atoms, such as a phenyl group or a benzyl group, are preferably used.

In each of the above-described organic residues which may be substituted, the substituent can be classified either as a group which contains a carbon atom(s) or as a group which contains no carbon atom. In the case of a group which contains a carbon atom(s), the carbon atom(s) is counted in the number of carbon atoms of the organic residue. Examples of groups which contain a carbon atom(s) include, and are not limited to, a carboxy group and an alkoxy group. Examples of groups which contain no carbon atom include, and are not limited to, a hydroxy group and a halo group.

Specific examples of the compound of formula (1) include, and are not limited to, 2-vinyloxyethyl (meth)acrylate, 3-vinyloxypropyl (meth)acrylate, 1-methyl-2-vinyloxyethyl (meth)acrylate, 2-vinyloxypropyl (meth)acrylate, 4-vinyloxybutyl (meth)acrylate, 1-methyl-3-vinyloxypropyl (meth)acrylate, 1-vinyloxymethylpropyl (meth)acrylate, 2-methyl-3-vinyloxypropyl (meth)acrylate, 1,1-dimethyl-2-vinyloxyethyl (meth)acrylate, 3-vinyloxybutyl (meth)acrylate, 1-methyl-2-vinyloxypropyl (meth)acrylate, 2-vinyloxybutyl (meth)acrylate, 4-vinyloxycyclohexyl (meth)acrylate, 6-vinyloxyhethyl (meth)acrylate, 4-vinyloxymethylcyclohexylmethyl (meth)acrylate, 3-vinyloxymethylcyclohexylmethyl (meth)acrylate, 2-vinyloxymethylcyclohexylmethyl (meth)acrylate, p-vinyloxymethylphenylmethyl (meth)acrylate, m-vinyloxymethylphenylmethyl (meth)acrylate, o-vinyloxymethylphenylmethyl (meth)acrylate, 2-(2-vinyloxyethoxy)ethyl (meth)acrylate, 2-(2-vinyloxyethoxy)ethyl acrylate, 2-(vinyloxyisopropoxy)ethyl (meth)acrylate, 2-(vinyloxyethoxy)propyl (meth)acrylate, 2-(vinyloxyethoxy)isopropyl (meth)acrylate, 2-(vinyloxyisopropoxy)propyl (meth)acrylate, 2-(vinyloxyisopropoxy)isopropyl (meth)acrylate, 2-(vinyloxyethoxyethoxy)ethyl (meth)acrylic acid, 2-(vinyloxyethoxyisopropoxy)ethyl (meth)acrylate, 2-(vinyloxyisopropoxyethoxy)ethyl (meth)acrylate, 2-(vinyloxyisopropoxyisopropoxy)ethyl (meth)acrylate, 2-(vinyloxyethoxyethoxy)propyl (meth)acrylate, 2-(vinyloxyethoxyisopropoxy)propyl (meth)acrylate, 2-(vinyloxyisopropoxyethoxy)propyl (meth)acrylate, 2-(vinyloxyisopropoxyisopropoxy)propyl (meth)acrylate, 2-(vinyloxyethoxyethoxy)isopropyl (meth)acrylate, 2-(vinyloxyethoxyisopropoxy)isopropyl (meth)acrylate, 2-(vinyloxyisopropoxyethoxy)isopropyl (meth)acrylate, 2-(vinyloxyisopropoxyisopropoxy)isopropyl (meth)acrylate, 2-(vinyloxyethoxyethoxyethoxy)ethyl (meth)acrylate, 2-(vinyloxyethoxyethoxyethoxyethoxy)ethyl (meth)acrylate, 2-(isopropenoxyethoxy)ethyl (meth)acrylate, 2-(isopropenoxyethoxyethoxy)ethyl (meth)acrylate, 2-(isopropenoxyethoxyethoxy)ethyl (meth)acrylate, 2-(isopropenoxyethoxyethoxyethoxy)ethyl (meth)acrylate, 2-(isopropenoxyethoxyethoxyethoxyethoxy)ethyl (meth)acrylate, polyethylene glycol monovinyl ether (meth)acrylate, and polypropylene glycol monovinyl ether (meth)acrylate. Among these compounds, 2-(2-vinyloxyethoxy)ethyl acrylate is particularly preferred in that it can easily balance the curability and viscosity of the composition. 2-(2-vinyloxyethoxy)ethyl acrylate will also be referred to herein as VEEA.

The content of the vinyl ether group-containing (meth)acrylate is preferably 0.1 to 50 mass %, 1 to 40 mass %, or 10 to 30 mass % based on the total amount of the ink composition. When the content of the vinyl ether group-containing (meth)acrylate based on the total amount of the ink composition is within the above ranges, the ink composition tends to have excellent storage stability. In addition, the viscosity of the composition tends to be reduced and the ejection stability tends to be further improved.

### 1.2.3.2.2. Polyfunctional (Meth)Acrylate

Examples of the polyfunctional (meth)acrylate include, and are not limited to, bifunctional (meth)acrylates such as dipropylene glycol diacrylate (DPGDA), diethylene glycol di(meth)acrylate, triethylene glycol di(meth)acrylate, tetraethylene glycol di(meth)acrylate, polyethylene glycol di(meth)acrylate, dipropylene glycol dimethacrylate, tripropylene glycol di(meth)acrylate (TPGDA), polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, EO (ethylene oxide) adduct di(meth)acrylate of bisphenol A, PO (propylene oxide) adduct di(meth)acrylate of bisphenol A, hydroxypivalic acid neopentyl glycol di(meth)acrylate, and polytetramethylene glycol di(meth)acrylate; and polyfunctional (meth)acrylates having three or more functional groups such as trimethylolpropane tri(meth)acrylate, EO-modified trimethylolpropane tri(meth)acrylate, pentaerythritol tri(meth)acrylate, pentaerythritol tetra(meth)acrylate, dipentaerythritol hexa(meth)acrylate (ADPH), ditrimethylolpropane tetra(meth)acrylate, glycerin propoxy tri(meth)acrylate, caprolactone-modified trimethylolpropane tri(meth)acrylate, pentaerythritol ethoxy tetra(meth)acrylate, and caprolactam-modified dipentaerythritol hexa(meth)acrylate (ADPH).

The content of the polyfunctional (meth)acrylate is preferably 1 to 50 mass %, 10 to 45 mass %, 15 to 40 mass %, or 20 to 35 mass % based on the total amount of the ink composition. When the content of the polyfunctional (meth)acrylate based on the total amount of the composition is within the above ranges, the adhesion of a coating tends to be improved.

### 1.3. Water

The ink jet ink composition according to the present embodiments preferably does not contain water. When the ink composition contains water, its content is less than 2 mass % based on the total amount of the ink composition, and is preferably low.

The water functions as a dispersant for the ink composition. Pure water such as RO water, distilled water, or deionized water, for example, may be used as the water.

When the ink composition contains water, the content of water is less than 2 mass %, preferably 1 mass % or less, or 0.1 mass % or less based on the total amount of the ink composition. While the lower limit of the content of water is not particularly limited, the content is preferably as low as possible and may be zero (0 mass %, including 0 mass % as obtained by rounding a content value to one decimal place). When the content of water is less than 2 mass %, the generation of foreign matter tends to be suppressed during storage of the ink composition under high-temperature conditions. The generation of foreign matter can be further suppressed when the ink composition contains no water.

### 1.4. Other Components

The ink composition according to the present embodiments may further contain additives such as a dispersant, a polymerization inhibitor, a slip agent, and a fluorescent brightener as necessary.

### 1.4.1. Polymerization Inhibitor

The ink composition according to the present embodiments may further contain a polymerization inhibitor. The polymerization inhibitor may be of a single type or of a combination of two or more types.

Examples of the polymerization inhibitor include, and are not limited to, p-methoxyphenol, hydroquinone monomethyl ether (MEHQ), 4-hydroxy-2,2,6,6-tetramethylpiperidine-N-oxyl, hydroquinone, cresol, t-butylcatechol, 3,5-di-t-butyl-4-hydroxytoluene, 2,2′-methylenebis(4-methyl-6-t-butylphenol), 2,2′-methylenebis(4-ethyl-6-butylphenol), and 4,4′-thiobis(3-methyl-6-t-butylphenol); and a hindered amine compound. Among them, a hindered amine compound is preferred.

While the hindered amine compound is not particularly limited, it is preferably one represented by the following formula (2) or (3):

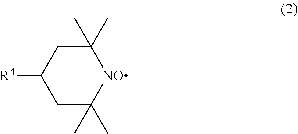

where R⁴ represents H—, O═, HO—, or R⁵—COO—, the R⁵ representing an alkyl group having 1 to 6 carbon atoms, or a substituted or unsubstituted aromatic group; or

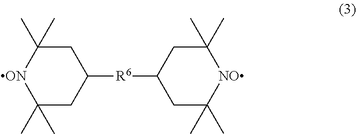

where R⁶ represents —OOC—R⁷—COO—, the R⁷ representing an alkyl group having 1 to 12 carbon atoms.

Examples of the alkyl group having 1 to 6 carbon atoms represented by R⁵ include, and are not limited to, a methyl group, an ethyl group, a propyl group, a butyl group, a pentyl group, and a hexyl group. A phenyl group is an example of the substituted or unsubstituted aromatic group represented by R⁵.

Examples of the alkyl group having 1 to 12 carbon atoms represented by R⁷ include, and are not limited to, a methyl group, an ethyl group, a propyl group, a butyl group, a pentyl group, a hexyl group, a heptyl group, an octyl group, an ethylhexyl group, a nonyl group, and a decyl group.

Examples of such hindered amine compounds include, and are not limited to, compounds having a 2,2,6,6-tetramethylpiperidine-N-oxyl skeleton, compounds having a 2,2,6,6-tetramethylpiperidine skeleton, compounds having a 2,2,6,6-tetramethylpiperidine-N-alkyl skeleton, and compounds having a 2,2,6,6-tetramethylpiperidine-N-acyl skeleton. Among them, bis(2,2,6,6-tetramethyl-4-piperidyl-1-oxyl)sebacate is preferred.

The content of the hindered amine compound is preferably 0.01 to 0.50 mass %, 0.01 to 0.10 mass %, or 0.01 to 0.05 mass % based on the total amount of the ink composition.

The content of the polymerization inhibitor is preferably 0.05 to 1 mass %, or 0.05 to 0.5 mass % based on the total amount of the ink composition.

### 1.4.2. Slip Agent

The ink composition according to the present embodiments may further contain a slip agent. The slip agent may be of a single type or of a combination of two or more types.

The slip agent is preferably a silicone surfactant, more preferably a polyester-modified silicone or polyether-modified silicone. Examples of the polyester-modified silicone include BYK-347 and 348, and BYK-UV 3500, 3510, and 3530, all manufactured by BYK Additives & Instruments). An example of the polyether-modified silicone is BYK-3570 manufactured by BYK Additives & Instruments.

The content of the slip agent is preferably 0.01 to 2 mass %, or 0.05 to 1 mass % based on the total amount of the ink composition.

### 1.4.3. Dispersant

The ink composition of the present embodiments may further contain a dispersant to improve the dispersibility of a colorant, etc. The dispersant may be of a single type or of a combination of two or more types.

The dispersant is not particularly limited and may be, for example, a dispersant such as a polymer dispersant commonly used to prepare a pigment dispersion. Specific examples include dispersants comprising, as a main component, one or more of a polyoxyalkylene polyalkylene polyamine, a vinyl polymer or copolymer, an acrylic polymer or copolymer, a polyester, a polyamide, a polyimide, a polyurethane, an amino polymer, a silicon-containing polymer, a sulfur-containing polymer, a fluorine-containing polymer, and an epoxy resin.

Examples of commercially available products of the polymer dispersant include AJISPER series manufactured by Ajinomoto Fine-Techno Co., Inc., SOLSPERSE series (SOLSPERSE 36000, etc.) available from Avecia or Noveon, DISPERBYK series manufactured by BYK Additives & Instruments, and DISPARLON series manufactured by Kusumoto Chemicals Ltd.

The content of the dispersant is preferably 0.1 to 2 mass %, 0.1 to 1.5 mass %, or 0.1 to 1.0 mass % based on the total amount of the ink composition.

### 1.4.4. Colorant

The ink composition of the present embodiments may further contain a colorant. The colorant may be of a single type or of a combination of two or more types.

The colorant is not particularly limited and may be, for example, a pigment or dye. The colorant may be of a single type or of a combination of two or more types.

The content of the colorant is preferably 0.5 to 15 mass %, more preferably 1.0 to 10 mass %, and even more preferably 2.0 to 7 mass % based on the total amount of the ink composition. When the content of the colorant is within the above ranges, the color development of the ink composition tends to be further improved.

The ink composition of the present embodiments may contain a pigment as the colorant. Examples of the pigment include, and are not limited to, organic pigments such as an azo pigment (e.g., an azo lake, an insoluble azo pigment, a condensed azo pigment, or a chelate azo pigment), a polycyclic pigment (e.g., a phthalocyanine pigment, a perylene pigment, a perinone pigment, an anthraquinone pigment, a quinacridone pigment, a dioxazine pigment, a thioindigo pigment, an isoindolinone pigment, or a quinophthalone pigment), a nitro pigment, a nitroso pigment, and aniline black; inorganic pigments such as carbon black (e.g., furnace black, thermal lamp black, acetylene black, or channel black), a metal oxide, a metal sulfide, and a metal chloride; and extender pigments such as calcium carbonate and talc.

The pigment may be added to the ink composition in the form of a pigment dispersion obtained by dispersing the pigment in water with a dispersant, or a pigment dispersion obtained either by dispersing in water a self-dispersing surface-treated pigment (hereinafter also referred to as “self-dispersing pigment”) in which hydrophilic groups have been introduced to the surfaces of pigment particles through a chemical reaction, or by dispersing in water a pigment coated with a polymer (hereinafter also referred to as “resin-dispersed pigment”). Among them, a self-dispersing pigment is preferably used. The use of a self-dispersing pigment tends to further improve the water repellency of a nozzle plate and the intermittent printing stability.

The pigment and the dispersant, constituting the above-described pigment dispersion, may each be of a single type or of a combination of two or more types.

The ink composition of the present embodiments may contain a dye as the colorant. Examples of the dye include, and are not limited to, acid dyes such as C.I. Acid Yellow, C.I. Acid Red, C.I. Acid Blue, C.I. Acid Orange, C.I. Acid Violet, and C.I. Acid Black; basic dyes such as C.I. Basic Yellow, C.I. Basic Red, C.I. Basic Blue, C.I. Basic Orange, C.I. Basic Violet, and C.I. Basic Black; direct dyes such as C.I. Direct Yellow, C.I. Direct Red, C.I. Direct Blue, C.I. Direct Orange, C.I. Direct Violet, and C.I. Direct Black; reactive dyes such as C.I. Reactive Yellow, C.I. Reactive Red, C.I. Reactive Blue, C.I. Reactive Orange, C.I. Reactive Violet, and C.I. Reactive Black; and disperse dyes such as C.I. Disperse Yellow, C.I. Disperse Red, C.I. Disperse Blue, C.I. Disperse Orange, C.I. Disperse Violet, and C.I. Disperse Black. The dye may be of a single type or of a combination of two or more types.

### 1.4.5. Fluorescent Brightener

The ink composition of the present embodiments may further contain a fluorescent brightener. The fluorescent brightener may be of a single type or of a combination of two or more types.

For example, the fluorescent brightener absorbs light having a wavelength of around 300 nm to 450 nm, and emits fluorescence having a wavelength of around 400 nm to 500 nm. Thus, when ultraviolet light is used as radiation, the fluorescent brightener in an ink increases the intensity of ultraviolet light, which is being applied to the ink, in the long-wavelength range, thereby improving the curability. Owing to the sensitization effect, the combined use of a photoinitiator and the fluorescent brightener tends to achieve superior curability as compared to the sole use of the photoinitiator.

Examples of the fluorescent brightener include naphthalene benzoxazolyl derivatives, thiophene benzoxazolyl derivatives, stilbene benzoxazolyl derivatives, coumarin derivatives, styrene biphenyl derivatives, pyrazolone derivatives, stilbene derivatives, styryl derivatives of benzene and biphenyl, bis(benzazol-2-yl) derivatives, carbostyril derivatives, naphthalimide derivatives, derivatives of dibenzothiophene-5,5′-dioxide, pyrene derivatives, and pyridotriazole.

A commercially available product may be used as the fluorescent brightener. Examples of commercially available products include TELALUX (registered trademark) OB (2,5-bis(5-tert-butyl-2-benzoxazolyl)thiophene) and KCB (1,4-bis(2-benzoxazolyl)naphthalene), available from Clariant Japan K.K.

The content of the fluorescent brightener in the ink composition is preferably 0.07 to 0.70 mass % or 0.10 to 0.50 mass % based on the total amount of the ink composition. When the content of the fluorescent brightener is within the above ranges, the curability of the ink composition tends to be improved.

### 1.5. Recording Medium

The ink composition according to the present embodiments can advantageously be used in an ejection step, which involves ejecting the ink composition onto a recording medium, in the below-described recording method. The recording medium is not particularly limited and may be, for example, an absorbent or non-absorbent recording medium.

Examples of the absorbent recording medium include plain paper such as electrophotographic paper, ink jet paper, and art paper, coated paper and cast paper for use in common offset printing.

Examples of the non-absorbent recording medium include a plastic medium made of polyvinyl chloride (PVC), polystyrene (PS), polyethylene terephthalate (PET), polypropylene (PP), polyethylene (PE), polycarbonate, cellulose diacetate, cellulose triacetate, cellulose propionate, cellulose butyrate, cellulose acetate butyrate, cellulose nitrate, polyvinyl acetal, or the like, which may be surface-treated, and media made of glass, metal, or wood.

The form of the recording medium is not particularly limited and may be, for example, a film, a board, or a cloth.

### 1.6. Method for Producing Ink Composition

The ink composition is produced (prepared) by stirring the components of the ink composition such that they are mixed sufficiently uniformly. In the present embodiments, the ink composition preparation process preferably includes a step of subjecting a mixture of a photopolymerization initiator and at least part of the monomer to at least one of an ultrasonic treatment and a heat treatment. This makes it possible to reduce the amount of dissolved oxygen in the prepared ink composition, thus obtaining an ink composition having excellent ejection stability and storage stability. The mixture may contain at least the above components, and may be one that further contains other component(s) of the ink composition, or one that contains all the components of the ink composition. The monomer contained in the mixture may be at least part of the entire monomer to be contained in the ink composition.

### 2. Recording Method

The recording method according to the present embodiments includes an ejection step of ejecting the ink composition according to the present embodiments and attaching it to a recording medium using a predetermined ink jet head.

### 2.1. Ejection Step

In the ejection step, the ink composition, which has been heated, is ejected from a liquid ejection head and attached to the recording medium. More specifically, a pressure generating means is driven to eject the ink composition, which has been filled into a pressure generating chamber of the liquid ejection head, from a nozzle. Such an ejection method is also called an ink jet method. Ejection conditions in the ejection step may be adjusted appropriately depending on the physical properties of the ink composition.

The recording medium is not particularly limited and may be the above-described one. Thus, an absorbent or non-absorbent recording medium may be used.

### 2.2. Curing Step

In the curing step, radiation is applied to the ink composition on the recording medium. When radiation is applied, a polymerization reaction of the monomer starts and the composition is cured to form a coating. If a photopolymerization initiator is present, it generates an active species (initiation species) such as a radical, an acid or a base. The polymerization reaction of the monomer is promoted by the function of the initiation species. If a photosensitizer is present, it absorbs radiation and becomes excited. The excited photosensitizer, upon contact with the photopolymerization initiator, promotes the decomposition of the photopolymerization initiator, thus achieving a more sufficient curing reaction.

Examples of the radiation include ultraviolet light, infrared light, visible light, and X-rays. The radiation is emitted toward the composition by a radiation source provided downstream of the liquid ejection head. The radiation source is not particularly limited and may be, for example, a UV light-emitting diode. The use of such a radiation source can achieve a reduction in the size and cost of the apparatus used. A UV light-emitting diode as a UV light source is small-sized, and therefore can be installed within an ink jet apparatus.

For example, the UV light-emitting diode can be mounted to a carriage (at its both ends in the medium width direction and/or on the medium transport direction side) on which the liquid ejection head for ejecting the ink composition is mounted. Owing to the above-described composition of the ink composition, low-energy and high-speed curing can be achieved. The irradiation energy is calculated by multiplying the irradiation time by the irradiation intensity. Therefore, the irradiation time can be reduced and the printing speed can be increased. On the other hand, the irradiation intensity can be reduced. This can reduce the rise in the temperature of a print, leading to a reduction in the odor of a cured coating.

### EXAMPLES

The present disclosure will be described in further detail using the following examples. It is to be noted that the present disclosure is not limited to the examples in any way.

### 1. Preparation of Ink Jet Ink Composition

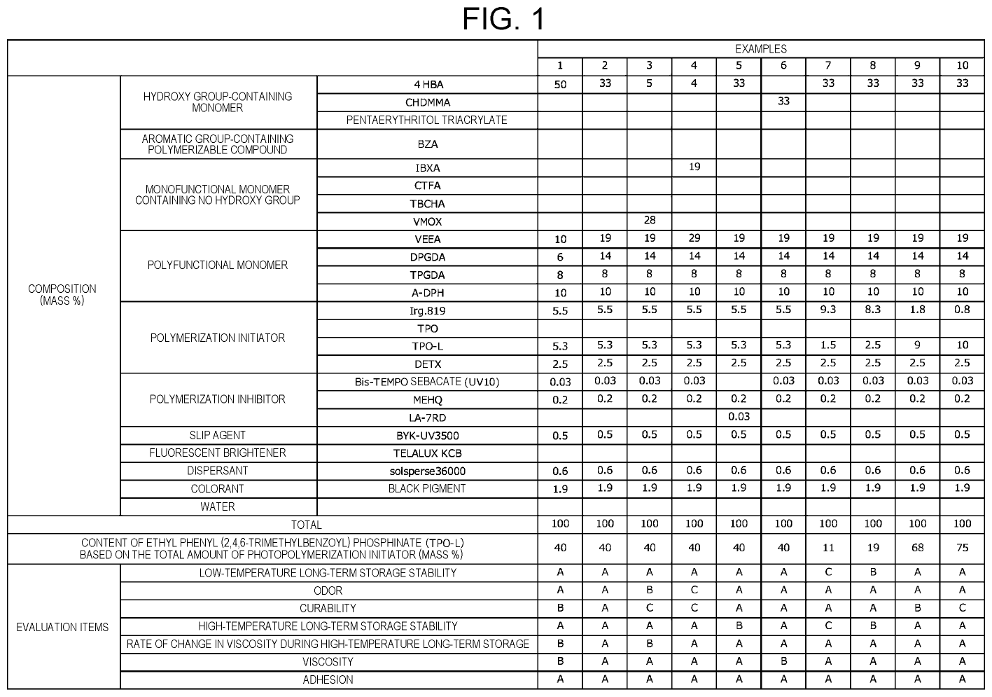

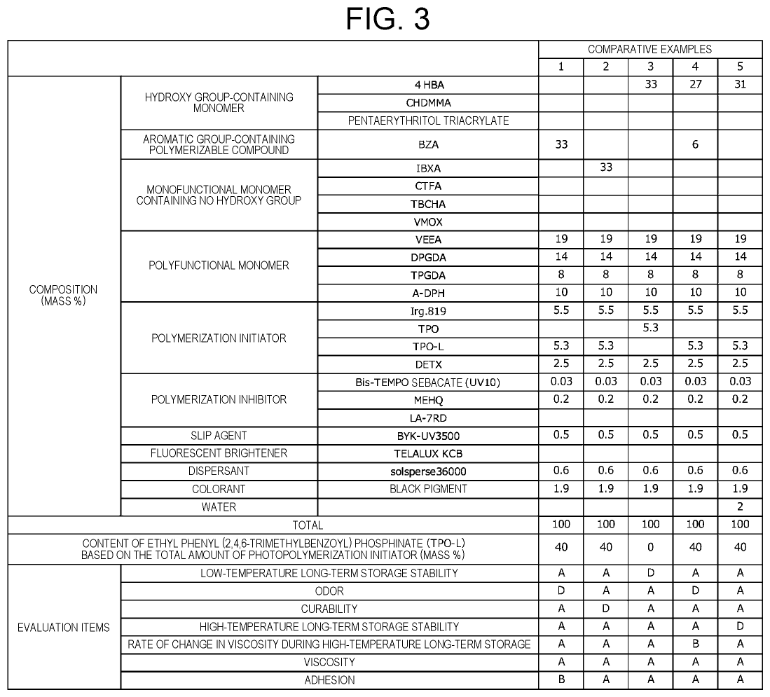

First, a colorant, a dispersant, and part of a monomer(s) were weighed and placed in a pigment dispersion tank, and a ceramic bead mill with a diameter of 1 mm was placed in the tank, and the mixture was stirred to obtain a pigment dispersion in which the colorant was dispersed in the monomer(s). Next, the remaining monomer(s), a resin, a photopolymerization initiator, a polymerization inhibitor, and a slip agent were placed, in such amounts as to make a composition as shown in FIG. 1, 2 or 3, into a mixing tank which was a stainless steel container, and mixed and stirred to completely dissolve the mixture. Thereafter, the above pigment dispersion was placed into the mixing tank, and the resulting mixture was further mixed and stirred at room temperature for 1 hour, followed by filtration through a 5-μm membrane filter to obtain an ink composition of each Example. The numerical values for the components of Examples, shown in FIGS. 1 through 3, are mass % unless otherwise specified.

The abbreviations and the components of the products, used in FIGS. 1 through 3, are as follows.

### Hydroxy Group-Containing Monomers

4HBA (Mitsubishi Chemical Corporation, 4-hydroxybutyl acrylate)
CHDMMA (Mitsubishi Chemical Corporation, 1,4-cyclohexanedimethanol monoacrylate)
Pentaerythritol triacrylate (trade name “Viscoat #802, manufactured by Osaka Organic Chemical Industry Ltd.) Aromatic Group-Containing Polymerizable Compound
BZA (trade name “Viscoat #160”, manufactured by Osaka Organic Chemical Industry Ltd., benzyl acrylate) Monofunctional Monomers Containing No Hydroxy Group
IBXA (manufactured by Osaka Organic Chemical Industry Ltd., isobornyl acrylate)
CTFA (trade name “Viscoat #200”, manufactured by Osaka Organic Chemical Industry Ltd., cyclic trimethylolpropane formal acrylate)
TBCHA (trade name “SR217”, manufactured by Sartomer Company, tert-butyl cyclohexanol acrylate)
VMOX (manufactured by BASF Corporation, vinylmethyloxazolidinone)

### Polyfunctional Monomers

VEEA (manufactured by Nippon Shokubai Co., Ltd., 2-(2-vinyloxyethoxy)ethyl acrylate)
DPGDA (trade name “SR508”, manufactured by Sartomer Company, dipropylene glycol diacrylate)
ADPH (manufactured by Shin-Nakamura Chemical Co., Ltd., pentaerythritol hexaacrylate) Photopolymerization Initiators
Irg. 819 (trade name “IRGACURE 819”, manufactured by BASF Corporation, bis(2,4,6-trimethylbenzoyl)-phenylphosphine oxide)
TPO (trade name “IRGACURE TPO”, manufactured by BASF Corporation, 2,4,6-trimethylbenzoyldiphenylphosphine oxide)
TPO-L (trade name “IRGACURE TPO-L”, manufactured by BASF Corporation, ethyl phenyl (2,4,6-trimethylbenzoyl)phosphinate)
DETX (trade name “Speedcure DETX”, manufactured by Lambson Ltd., 2,4-diethylthioxanthen-9-one) Polymerization Inhibitors
MEHQ (trade name “p-methoxyphenol”, manufactured by Kanto Chemical Co., Inc., hydroquinone monomethyl ether)
Bis-TEMPO Sebacate (UV10) (manufactured by Seiko Chemical Co., Ltd., bis(2,2,6,6-tetramethyl-4-piperidyl-1-oxyl) sebacate)
LA-7RD (manufactured by Adeka Corporation, 2,2,6,6-tetramethyl-4-hydroxypiperidine-1-oxyl) Slip Agent
BYK-UV3500 (manufactured by BYK Additives & Instruments, acryloyl group-containing polyether-modified polydimethylsiloxane)

### Fluorescent Brightener

TELALUX KCB (manufactured by Clariant Japan K.K., 1,4-bis(2-benzoxazolyl)naphthalene)

### Dispersant

Solsperse 36000 (manufactured by Lubrizol Corporation, polymer dispersant)

### Colorant

Black pigment (trade name “Microlith Black C-K”, manufactured by Ciba Japan K.K.)

### 2. Evaluation Methods

### 2.1. Evaluation of Low-Temperature Long-Term

### Storage Stability

Each of the prepared ink compositions was filled into a glass bottle and stored in an environment at −20° C. for 7 days. 10 ml of the ink composition after storage was filtered through a 10-μm filter. The low-temperature long-term storage stability was evaluated based on the number of foreign particles after filtration. The evaluation criteria are as follows. The rating A (exceptional), the rating B (excellent), and the rating C (good) were evaluated as acceptable, while the rating D (poor) was evaluated as unacceptable.
A: The number of foreign particles is less than 10.
B: The number of foreign particles is not less than 10 and less than 30.
C: The number of foreign particles is not less than 30 and less than 50.
D: The number of foreign particles is not less than 50.

### 2.2. Evaluation of Odor

The odor of each of the prepared ink compositions was smelled and evaluated. In order to reduce individual differences in the sense of smell, 10 people tested the same sample and scored the odor as follows. The average score of the 10 people was calculated, and the odor was rated at four levels, A to D, based on the average score. The rating A (exceptional), the rating B (excellent), and the rating C (good) were evaluated as acceptable, while the rating D (poor) was evaluated as unacceptable.
0 points: no odor or barely noticeable odor
1 point: slight odor
2 points: easily noticeable odor
3 points: strong odor
A: The average score is not less than 0 points and less than 0.5 points.
B: The average score is not less than 0.5 points and less than 1.5 points.
C: The average score is not less than 1.5 points and less than 2.5 points.
D: The average score is not less than 2.5 points and less than 3.0 points.

### 2.3. Evaluation of Curability

An evaluation of swab load tackiness was performed. In particular, each ink composition was applied to a polyvinyl chloride medium with a bar coater to a thickness of 10 μm to form a coating, and the coating was irradiated with ultraviolet light at a predetermined irradiation intensity and at a speed of 0.04 sec/cm. An LED having a peak wavelength of 395 nm was used as a light source. The surface of the coating was then rubbed with a cotton swab, and an irradiation energy at which the cotton swab was no longer colored was measured to evaluate the curability. The evaluation criteria are shown below. The rating A (exceptional), the rating B (excellent), and the rating C (good) were evaluated as acceptable, while the rating D (poor) was evaluated as unacceptable.
A: The irradiation energy at which the cotton swab is no longer colored is less than 300 mJ/cm².
B: The irradiation energy at which the cotton swab is no longer colored is not less than 300 mJ/cm² and less than 500 mJ/cm².
C: The irradiation energy at which the cotton swab is no longer colored is not less than 500 mJ/cm² and less than 700 mJ/cm².
D: The irradiation energy at which the cotton swab is no longer colored is not less than 700 mJ/cm².

### 2.4. Evaluation of High-Temperature Long-Term Storage Stability

Each of the prepared ink compositions was filled into a glass bottle and stored in an environment at 70° C. for 8 days. 10 ml of the ink composition after storage was filtered through a 10-μm filter. The high-temperature long-term storage stability was evaluated based on the number of foreign particles after filtration. The evaluation criteria are as follows. The rating A (exceptional), the rating B (excellent), and the rating C (good) were evaluated as acceptable, while the rating D (poor) was evaluated as unacceptable.
A: The number of foreign particles is less than 10.
B: The number of foreign particles is not less than 10 and less than 30.
C: The number of foreign particles is not less than 30 and less than 50.
D: The number of foreign particles is not less than 50.

### 2.5. Evaluation of the Rate of Change in Viscosity During High-Temperature Long-Term Storage

For each of the ink compositions which had been stored in an environment at 70° C. for 8 days, the viscosity was measured before and after the storage based on JIS Z 8803 in an environment at 25° C. using a rotational viscometer (product name “Rheometer MCR-301”, manufactured by Anton Paar). The evaluation criteria are as follows:
A: The rate of change in viscosity is less than 5%.
B: The rate of change in viscosity is not less than 5% and less than 10%.
C: The rate of change in viscosity is not less than 10% and less than 15%.
D: The rate of change in viscosity is not less than 15%.

### 2.6. Evaluation of Viscosity

The viscosity of each ink composition immediately after its preparation was measured based on JIS Z 8803 in an environment at 20° C. using a rotational viscometer (product name “Rheometer MCR-301”, manufactured by Anton Paar). The evaluation criteria are as follows:
A: The viscosity is less than ±5% relative to 20 mPa·s.
B: The viscosity is not less than ±5% and less than ±10% relative to 20 mPa·s.
C: The viscosity is not less than ±10% and less than ±15% relative to 20 mPa·s.
D: The viscosity is not less than ±15% relative to 20 mPa·s.

### 2.7. Evaluation of Adhesion

Each of the ink compositions of Examples and Comparative Examples was applied to a PET film (PET50A PL Thin [trade name], manufactured by Lintec Corporation) in such an amount as to form a coating having a thickness of 10 μm (thickness after curing), and was irradiated with radiation (UV light) under the same conditions as in the evaluation of curability until no scratches were formed in the coating. Each of the ink compositions of Examples and Comparative Examples was thus cured to produce a recorded product. The recorded product was evaluated by a cross-cut method in accordance with JIS K 5600-5-6.

More specifically, a cutter blade was applied to a cured coating at a right angle, and the coating was cut to form a grid of 10×10 squares with a line-to-line spacing of 1 mm. A transparent adhesive tape (25 mm wide) having a length of about 75 mm was attached to the grid, and the tape was rubbed thoroughly with a finger so that the cured coating would be visible through it. Next, within 5 minutes after attaching the tape to the grid, the tape was securely peeled off the cured coating at an angle of around 60° in 0.5 to 1.0 seconds, and the state of the grid was visually observed. The evaluation criteria are as follows.
A: No peeling of the cured coating was observed, or peeling of the cured coating was observed in less than 1% of the grid.
B: Peeling of the cured coating was observed in not less than 1% and less than 10% of the grid.
C: Peeling of the cured coating was observed in not less than 10% and less than 35% of the grid.
D: Peeling of the cured coating was observed in not less than 35% of the grid.

### 3. Evaluation Results

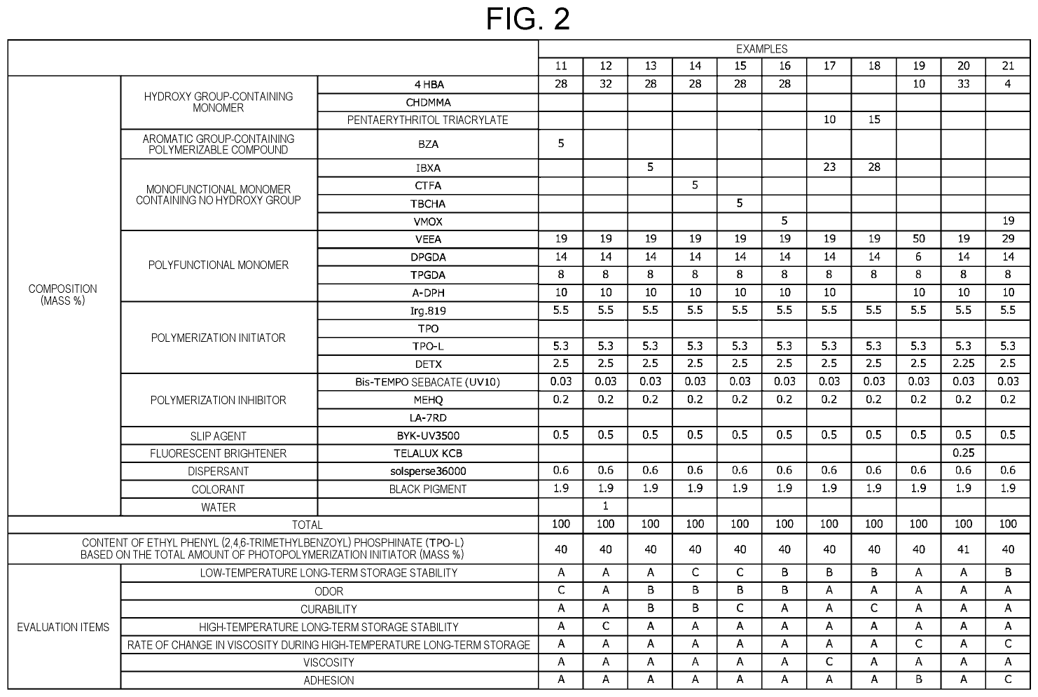

FIGS. 1 through 3 show the chemical compositions of the ink compositions of the examples as well as the evaluation results. As can be seen in FIGS. 1 and 2, the ink compositions of Examples 1 to 21, which each contain ethyl phenyl (2,4,6-trimethylbenzoyl)phosphinate and a hydroxy group-containing monomer, contain no aromatic group-containing polymerizable compound, or contain an aromatic group-containing polymerizable compound in an amount of 5.0 mass % or less based on the total amount of the ink composition, and contain no water, or contain water in an amount of less than 2 mass % based on the total amount of the ink composition, have a good level of odor, curability, and storage stability under both low-temperature conditions and high-temperature conditions.

In particular, comparison of data between the Examples and Comparative Examples 1 and 4 indicates that compared to the ink compositions of Comparative Examples 1 and 4, which each contain the aromatic group-containing polymerizable compound in an amount of more than 5.0 mass % based on the total amount of the ink composition, the ink compositions of the Examples have a reduced odor.

Comparison of data between the Examples and Comparative Example 2 indicates that compared to the ink composition of Comparative Example 2, which contains no hydroxy group-containing monomer, the ink compositions of the Examples have improved curability.

Comparison of data between the Examples and Comparative Example 3 indicates that compared to the ink composition of Comparative Example 3, which does not contain ethyl phenyl (2,4,6-trimethylbenzoyl)phosphinate, the ink compositions of the Examples have improved storage stability under low-temperature conditions.

Further, comparison of data between the Examples and Comparative Example 5 indicates that compared to the ink composition of Comparative Example 5, which contains water in an amount of not less than 2.0 mass % based on the total amount of the ink composition, the ink compositions of the Examples have improved storage stability under high-temperature conditions.

What is claimed is:

1. An ink jet ink composition comprising a photopolymerization initiator and a hydroxy group-containing monomer, containing no aromatic group-containing polymerizable compound, or containing an aromatic group-containing polymerizable compound in an amount of 5.0 mass % or less based on the total amount of the ink jet ink composition, and containing no water, or containing water in an amount of less than 2 mass % based on the total amount of the ink jet ink composition,
wherein the photopolymerization initiator comprises ethyl phenyl (2,4,6-trimethylbenzoyl)phosphinate.

2. The ink jet ink composition according to claim 1, wherein the content of the hydroxy group-containing monomer is 5.0 to 50 mass % based on the total amount of the ink jet ink composition.

3. The ink jet ink composition according to claim 1, wherein the hydroxy group-containing monomer comprises a hydroxy group-containing monofunctional monomer.

4. The ink jet ink composition according to claim 1, containing no aromatic group-containing polymerizable compound, or containing an aromatic group-containing polymerizable compound in an amount of 0.1 mass % or less based on the total amount of the ink jet ink composition.

5. The ink jet ink composition according to claim 1, containing no water, or containing water in an amount of less than 0.1 mass % or less based on the total amount of the ink jet ink composition.

6. The ink jet ink composition according to claim 1, containing a vinyl ether group-containing (meth)acrylate represented by the following formula (1):
CH₂═CR¹—COOR²—O—CH═CH—R³ (1)
where R¹ is a hydrogen atom or a methyl group, R² is a divalent organic residue having 2 to 20 carbon atoms, and R³ is a hydrogen atom or a monovalent organic residue having 1 to 11 carbon atoms.

7. The ink jet ink composition according to claim 1, containing a hindered amine compound represented by the following formula (2) or (3): 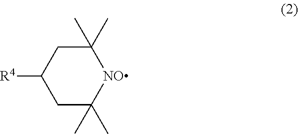
where R⁴ represents H—, O═, HO—, or R⁵—COO—, the R⁵ representing an alkyl group having 1 to 6 carbon atoms, or a substituted or unsubstituted aromatic group; or 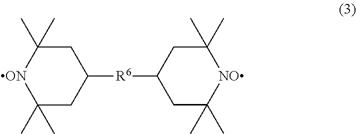
where R⁶ represents —OOC—R⁷—COO—, the R⁷ representing an alkyl group having 1 to 12 carbon atoms.

8. The ink jet ink composition according to claim 1, containing a monofunctional monomer containing no hydroxy group, the monofunctional monomer comprising one or more selected from the group consisting of an aliphatic ring-containing monomer, an oxygen-containing cyclic monomer, and a nitrogen-containing cyclic monomer.

9. The ink jet ink composition according to claim 8, wherein the monofunctional monomer containing no hydroxy group comprises one or more selected from the group consisting of isobornyl (meth)acrylate, cyclic trimethylolpropane formal acrylate, tert-butyl cyclohexanol acrylate, and vinylmethyloxazolidinone.

10. The ink jet ink composition according to claim 1, wherein the content of ethyl phenyl (2,4,6-trimethylbenzoyl)phosphinate is 2 to 10 mass % based on the total amount of the ink jet ink composition.

11. The ink jet ink composition according to claim 1, wherein the content of ethyl phenyl (2,4,6-trimethylbenzoyl)phosphinate is 15 to 100 mass % based on the total amount of the photopolymerization initiator.

12. A recording method comprising an ejection step of ejecting the ink jet ink composition according to claim 1 from an ink jet head and attaching the composition to a recording medium.
